(19) United States
(12) Patent Application Publication
(10) Pub. No.: US 2005/0249246 A1
(43) Pub. Date: Nov. 10, 2005

(54) Method of transporting data streams through an sdh switched network

(76) Inventor: Reidar Schumann-Olsen, Lier (NO)

Correspondence Address: ERICSSON INC., 6300 LEGACY DRIVE, M/S EVR C11, PLANO, TX, 75024, US

(21) Appl. No.: 10/519,595

(22) PCT Filed: Jul. 12, 2002
(86) PCT No.: PCT/NO02/00261

§ 371 Date: Dec. 28, 2004

(51) Int. Cl. H04J 3/04

(52) U.S. Cl. 370/535

(57) ABSTRACT

The present invention discloses a method transporting bit rates through Synchronous Digital Hierarchy (SDH) switched networks with hit rates not specified in the SDH standard. According to the present invention, a hit stream is demultiplexed onto a number of SHDSL lines which in turn are mapped into SDH C-12 data containers. To match the bit rates of each of the SHDSL lines to the C-12 containers, both the data bit positions (D-bits) and the unused overhead bit positions (R-bits) of the C-12 containers are utilised. The present invention is best adapted to demultiplex bit rates of about 8 Mbit/s onto four SHDSL lines as the bit rate of each of the SHDSL line then gives a perfect match of the number of repeating R-bits in the C-12 container.

### FIELD OF THE INVENTION

The present invention is related to data communication systems, in particular to a method transporting certain bit rates through Synchronous Digital Hierarchy (SDH).

### BACKGROUND OF THE INVENTION

SDH is a well-established signal distribution system for transferring multi-gigabit rates over transporting networks e.g. in fixed telecommunication networks and radio access networks of mobile telephone systems. Plesiochronous Digital Hierarchy (PDH) is an older system offering lower bit rates, but it is still being widely used e.g. in data transport towards broadband end users.

Transition mechanisms for transferring PDH bit rates into SDR exist. The basic principle for this can be found in the ITU G.707 recommendation. In addition to this, it is also defined standards for how to transport SDH elements in PDH. The ITU recommendation G.832 defines this for 34 Mbit/s up to 140 Mbit/s transmission.

However, no standards for the transport of bit rates in the area between 2 Mbit/s and 34 Mbit/s are defined for SDH. A problem then obviously appears when the PDH standard E2 for 8 Mbit/s is being used.

The application WO9409577 discloses a system arranged to operate at rates below 140 Mbit/s in SDH, still being compatible with PDH. However, the application does not give any further details on how to solve this problem other than indicating some kind of utilization of overhead capacity.

### SUMMARY OF THE INVENTION

It is an object of the present invention to provide a method that eliminates the drawbacks described above. The features defined in the independent claim enclosed characterise this method.

In particular, the present invention discloses a method of transporting a first data stream of a first bit rate, such as E1, through a SDH switched network from a first endpoint to a second endpoint using TDM, by demultiplexing the first data stream from the first endpoint onto a number of SHDSL lines, each having data streams of a SHDSL adjusted bit rate mapping each of the data streams into data bit and/or unused overhead bit positions of SDH specified data containers, and multiplexing the data containers into the SDH switched network.

### BRIEF DESCRIPTION OF THE DRAWINGS

In order to make the invention more readily understandable; the discussion that follows will refer to the accompanying drawings.

FIG. 1 shows a block diagram of an end-to-end connection according to a preferred embodiment of the present invention,

FIG. 2 shows a SDH C-12 container for transport of E1 signals on 2.048 Mbit/s,

FIG. 3 shows a block diagram of an end-to-end connection according to a general embodiment of the present invention.

### DETAILED DESCRIPTION OF THE PRESENT INVENTION

In the following, a preferred embodiment of the present invention will be described and thereafter showing how the invention may be utilised in a more general way.

As already mentioned no standard for transporting bit rates between 2 Mbit/s and 34 Mbit/s in SDH exists. This is a problem especially because the bit rate of 8 Mbit/s is a common bit rate e.g. for end users' broadband connections. Thus, the preferred embodiment of the present invention discloses a solution for transporting a data rate of approximately 8 Mbit/s through an SDH network.

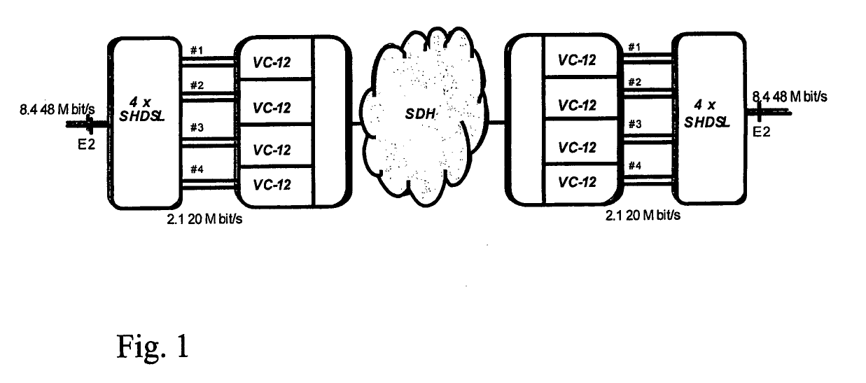

For Single pair High Speed Digital Subscriber Line (SHDSL), however, it is defined a data formatting structure for the insertion of an overhead channel and data interleaving method for single and dual line pair transmission. The present invention uses this as a basis when demultiplexing a 8.448 Mbit/s E2 bit rate into a quad line system as shown in FIG. 1, and using a payload bit rate of 2.112 Mbit/s on each line giving a total capacity of the accurate E2 bit rate.

Further, on each line there is added an overhead of 8 Kbit/s giving each line a total rate of 2.120 Mbit/s. This overhead incorporate a framing word, alarm indication and CRC transmission quality measurement.

The transparent data of a SDH system is structured in so-called containers, in the preferred embodiment this is a VC-12 container. For transporting the data of the SHDSL lines over SDH, this is done by taking into use some of the free space capacity in a VC-12 container in order to transport the complete SHDSL payload and overhead end-to-end. The VC-12 containers are then-multiplexed into the SDH transport network, and the inverse procedure is executed at the receiving side as indicated in FIG. 1.

A part of the above-mentioned overhead is the SHDSL frame synchronisation word. This frame overhead is used for the purpose of measuring the delay difference between the lines in order to secure the end-to-end integrity of the SHDSL signal. The transmission quality and alarm measurement is end-to-end transparent throughout the connection of FIG. 1 including both the SHDSL and SDH sections, as it should be possible with the present invention to transport the overhead through the SDR section.

As already indicated the VC-12 container is transparently through connected in a SDH switching network. The total capacity of a VC-12 is 2.240 Mbit/s and the standard defines how an E1 signal with 2.048 Mbit/s is transported in such a container.

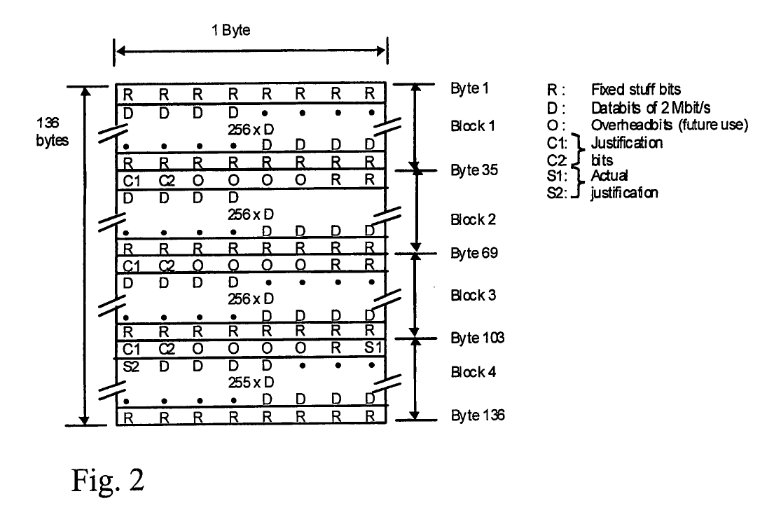

Within a VC-12, the 2.048 Mbit/s data is mapped into a C-12 container. The C-12 container is shown in FIG. 2. The actual bit rate of the C-12 container is 2.176 Mbit/s, but the data rate of the payload (D-bits) is accurate 2.048 Mbit/s. The C-12 container is divided into 4 blocks, each of 34 bytes length and of 125 μs duration.

As can be seen from FIG. 2, in addition to the E1 data bits (D), there are overhead bits giving a total bit rate of 2.176 Mbit/s for the C-12 container. However, most of the other bits (R-bits) are fixed and unused by the standard. According to the present invention this extra capacity is being used to increase the payload capacity of the C-12 container.

Therefore, to transport the 8.448 Mbit/s bit stream, the rate of each of the four transmission systems needs to be 2.120 Mbit/s, i.e. 72 kbit/s extra compared to the payload bit rate of 2.048 Mbit/s. This capacity is achieved by the use of the extra R-bits in the C-12. Since each block has a duration of 125 μs, there are 8 blocks in one second, and totally (72 kbit/s*1/8 s) 9 R-bits will be needed. This can be achieved by the use of 8 R-bits in byte number 34, 68, 102, 136 and bit number 7 in byte 1, 35, 69, 103. In this way, exactly all the R-bits that is repeated in all blocks (in byte 103, only bit number 7 is an R-bit) are being used to achieve the required bit rate of 2.120 Mbit/s.

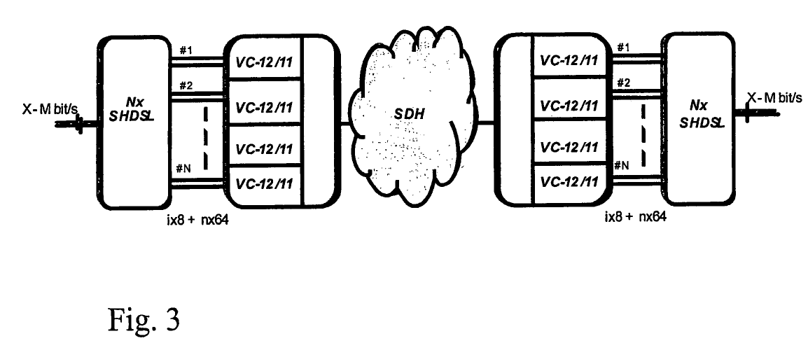

The principle of inverse multiplexing a E2 8.448 Mbit/s across a SDH network as described for the preferred embodiment can also be used for any E2 transmission access system like the radio and fibre optical systems of Sonet. In general, the present invention discloses a method for transporting a SHDSL transmission frame over a SDH network using inverse multiplexing of VC's and SHDSL transmission lines. The transport in SDH can either be done via VC-12 as described above, or via VC-11 according to the North American standard. Any combination of i×8 kbit/s and n×64 kbit/s as defined in the SHDSL standard can be transported. According to the present invention, extra available stuffing capacity in the VC-11/12 overhead is used to match the actual bit rates. FIG. 3 shows an overview of the general concept.

The main advantage of the present invention is that it allows transport of the not standardised data rates between 2 Mbit/s and 34 Mbit/s through a SDH switched network. This is provided with a minimum of additional processing by fragmenting the data stream onto SHDSL lines and adopting the free space capacity in the C-12 containers.

1-10. (canceled)

11. A method of transporting a first data stream of a first bit rate through a Synchronous Digital Hierarchy (SDH) switched network from a first endpoint to a second endpoint using TDM, said method comprising the steps of:
a) demultiplexing the first data stream from the first endpoint onto a number of Single-pair High-speed Digital Subscriber Lines (SHDSLs) each having a second data stream of a SHDSL adjusted second bit rate;
b) mapping each of the second data streams into data bit or unused overhead bit positions of SDH specified data containers; and,
c) multiplexing the data containers into the SDH switched network.

12. The method according to claim 11, wherein steps a) and b) are switched in order to retrieve the first bit rate at the second endpoint side.

13. The method according to claim 11, wherein, in each of the second data streams, there is included an overhead of a third bit rate incorporating framing words, alarm indication or a transmission quality measurement.

14. The method according to claim 13, wherein at least a part of the overhead includes frame synchronization words for measuring delay differences between the SHDSL lines for securing end-to-end integrity of the second data streams.

15. The method according to claim 11, wherein the data containers are C-12 containers with a bit rate of 2.176 Mbits/s.

16. The method according to claim 15, wherein the data bit positions are C-12 D-bit positions and the unused overhead bit positions are C-12 R-bit positions.

17. The method according to claim 11, wherein the number of SHDSLs is four, and the second bit rate is 2.120 Mbit/s.

18. The method according to claim 17, wherein the first bit rate is 8.448 Mbit/s and the third bit rate is 8 Kbit/s.

19. The method according to claim 17, wherein the R-bit positions used are 8 R-bit positions in each of byte 34, 68, 102 and 136 in addition to bit number 7 in byte 1, 35, 69, and 103.

20. The method according to claim 11, wheerein the first bit rate is X Mbits/s, the second bit rate is i×8 kbits/s (nε[1,7]) plus n×64 kbits/s (nε[1,36]), and the number of SHDSL lines is N and the number of data containers are N, wherein N and X are any integer number.
